(19) United States
(12) Patent Application Publication
(10) Pub. No.: US 2012/0121102 A1
(43) Pub. Date: May 17, 2012

(54) EARPHONE ANTENNA DEVICE FOR RECEIVING DUAL BAND SIGNAL

(75) Inventor: Kwang Seok JANG, Suwon-si (KR)

(73) Assignee: SAMSUNG ELECTRONICS CO. LTD., Suwon-si (KR)

(21) Appl. No.: 13/291,518

(22) Filed: Nov. 8, 2011

(30) Foreign Application Priority Data
Nov. 11, 2010 (KR) 10-2010-0111956

(51) Int. Cl. H04R 1/10

(52) U.S. Cl. 381/74

(57) ABSTRACT

An earphone antenna device is provided. The earphone antenna device includes a first antenna connected to an earphone, configured in the form of a wire that is separate from an audio line, for receiving a first band frequency, and a connector connecting the earphone to a terminal device. The connector includes a Radio Frequency (RF) connected to the first antenna, for filtering the first band frequency and for restraining other band frequencies, and a second antenna connected between the RF filter and an internal path of the connector connected to the terminal device, for receiving a second band frequency higher than the first band frequency.

### PRIORITY

This application claims the benefit under 35 U.S.C. §119(a) of a Korean patent application filed on Nov. 11, 2010 in the Korean Intellectual Property Office and assigned Serial No. 10-2010-0111956, the entire disclosure of which is hereby incorporated by reference.

### BACKGROUND OF THE INVENTION

1. Field of the Invention

The present invention relates to an earphone antenna device. More particularly, the present invention relates to an earphone antenna device for receiving a dual band signal.

2. Description of the Related Art

In recent years, in the trend of digital convergence, antennas for portable broadcasting (e.g., Terrestrial-Digital Multimedia Broadcasting (T-DMB), Satellite-DMB (S-DMB), and the like), a Global Positioning System (GPS) and Connectivity (e.g., Bluetooth, Radio Frequency Identification (RFID), Near Field Communication (NFC), Zigbee, Ultra Wideband (UWB), Electronic Fee Collection (EFC)), as well as mobile communication antennas for 2nd Generation (2G) (e.g., a Code Division Multiple Access (CDMA), a Personal Communication Service (PCS) and the like) and 3rd Generation (3G) (e.g., Wideband CDMA (WCDMA), Personal Communication Services (PCS), Data Communication Services (DCS), Global System for Mobile communications (GSM), and the like) are simultaneously implemented in a mobile phone.

For example, an antenna for a T-DMB is configured by a retractable type antenna, a removable type antenna, or an earphone integral type antenna. Because an antenna for S-DMB is configured by a diversity antenna, there is a need for two antennas. In a case of a mobile terminal including a DMB function, because a frequency in the T-DMB is low, the wavelength is long and there is a need for a long antenna. Because a frequency is high in an S-DMB, the wavelength is short and there is a need for a relative short antenna.

Accordingly, in a mobile terminal including a DMB function, as the number of antennas is increased, the mounting space and costs of a component are also increased. Further, a multi-media terminal performing a data communication function requires a Frequency Modulation (FM) antenna for receiving music broadcasting and an antenna (e.g., a Wireless Fidelity (Wi-Fi) antenna, a GPS antenna, and the like) for downloading data. In this case, since the Wi-Fi signal or the GPS signal has a higher frequency in comparison with an FM signal, there is a need for antennas having different lengths. Accordingly, because a plurality of antennas should be installed in the mobile terminal, the sensitivity of a received signal is influenced according to a gripping location of the user. As a result, a location of an antenna mounted in the mobile terminal should be considered.

As described above, a mobile terminal receiving signals of multiple frequencies is significantly limited by antenna performance due to the implementation of multiple antennas and causes performance problems. In general, when using a mobile terminal, an earphone may be used to receive an audio signal in a playback mode of a phone or a multi-media terminal Further, the earphone tends to be implemented to perform an antenna function as well as playback of the audio signal. However, the earphone antenna has a structure for receiving a single-band signal.

### SUMMARY OF THE INVENTION

Aspects of the present invention are to address at least the above-mentioned problems and/or disadvantages and to provide at least the advantages described below. Accordingly, an aspect of the present invention is to provide an earphone antenna device that includes multiple antennas for receiving multiple frequency signals in an earphone device, and is designed with a structure in which an antenna receiving a higher frequency involves a part of another antenna receiving a lower frequency, thereby improving the performance of a mobile terminal, and reducing the number of antennas and manufacturing costs. In a case of a terminal supporting S-DMB/T-DMB broadcasting, an earphone-antenna being a T-DMB antenna is implemented to share one side of a path with the S-DMB antenna.

In accordance with an aspect of the present invention, an earphone antenna device is provided. The earphone antenna device includes a first antenna connected to an earphone, configured in the form of a wire that is separate from an audio line, for receiving a first band frequency, and a connector connecting the earphone to a terminal device, the connector includes a Radio Frequency (RF) filter connected to the first antenna, for filtering the first band frequency and for restraining other band frequencies, and a second antenna connected between the RF filter and an internal path of the connector connected to the terminal device, for receiving a second band frequency higher than the first band frequency, wherein the first band frequency received through the first antenna and the second band frequency received through the second antenna are transferred to the terminal device through the internal path.

In accordance with another aspect of the present invention, an earphone antenna device is provided. The earphone antenna device includes a case connected to an earphone and having a second antenna therein, a first antenna connected to the case, configured in the form of a wire that is separate from an audio line, for receiving a first band frequency, and a connector connected to the first antenna, and connecting the earphone antenna device to a terminal device, the case includes a second antenna connected to the earphone, for receiving a second band frequency, and a RF filter connected to the second antenna, for filtering the second band frequency and for restraining other band frequencies, wherein the first band frequency received through the first antenna and the second band frequency received through the second antenna are transferred to the terminal device through an internal path of the connector.

An earphone antenna device according to an exemplary embodiment of the present invention includes and integrates multiple antennas to reduce the number of components, thereby reducing the cost.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating an earphone antenna device according to an exemplary embodiment of the present invention;

FIG. 2 is a block diagram illustrating an earphone antenna device with a multiple resonance antenna according to an exemplary embodiment of the present invention;

FIG. 3 is a block diagram illustrating a second antenna configured in the form of a pattern according to an exemplary embodiment of the present invention; and

FIG. 4 is a block diagram illustrating an earphone antenna device with a multiple resonance antenna according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An earphone antenna uses a T20 pin or micro-Universal Serial Bus (USB). An earphone antenna for a dual band according to an exemplary embodiment of the present invention may be used in two types of interfaces. Hereinafter, it is assumed that the dual band is Terrestrial-Digital Multimedia Broadcasting (T-DMB)/Satellite-DMB (S-DMB). The dual band is also applicable to radio Frequency Modulation(FM)/SDMB, T-DMB/Wireless Fidelity (Wi-Fi), T-DMB/Global Positioning System (GPS), FM/Wi-Fi, FM/GPS, and China Multimedia Broadcasting (CMMB)/GPS. Accordingly, an earphone antenna device for a dual band of T-DMB/S-DMB may share a dual band antenna in an earphone to improve performance, reduce the number of antennas, and reduce manufacturing costs. Further, the number of the antennas may be reduced to arrange the antennas in a position that is favorable to a gripping location of the user.

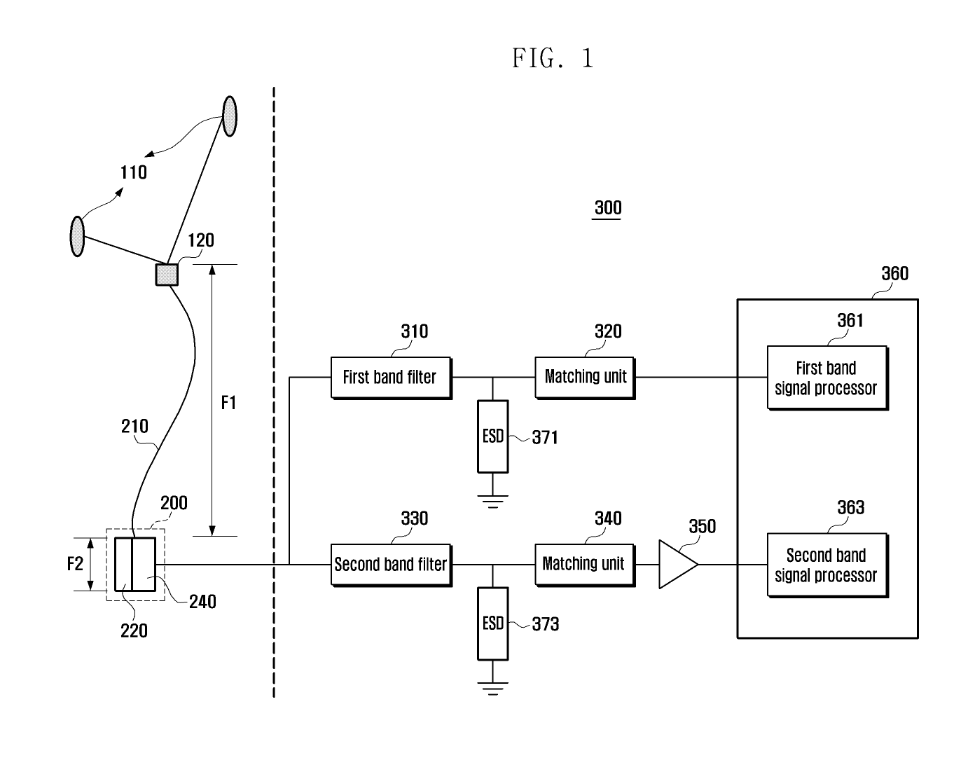

FIG. 1 is a block diagram illustrating a configuration of an earphone antenna device according to an exemplary embodiment of the present invention.

Referring to FIG. 1, an earphone 110 connects with a volume controller 120 via a wired line as a speaker. A first antenna 210 for receiving a first band frequency is connected between the earphone 110 and a connector 200. In this case, the first antenna 210 may be implemented by a wire antenna being a conductor. An audio line (not illustrated) may connect with the first antenna 210 in parallel. The connector 200 may be implemented by a T20 pin or micro-USB. In an exemplary implementation, the connector 200 may be composed of a second antenna 220 for receiving a second band frequency and a connecting unit 240 for connecting with another device (e.g., a mobile terminal).

Hereinafter, it is assumed that the first antenna 210 is an antenna for receiving a T-DMB band frequency F1 (174 MHz-212 MHz) and the second antenna 220 is an antenna for receiving an S-DMB band frequency F2 (2642 MHz, 2.64 GHz).

However, the first antenna 210 may be designed to receive at least one signal (e.g., a radio signal (an FM signal and the like), a television signal, or a CMMB signal) having a lower frequency in comparison with a signal received through the second antenna 220. The second antenna 220 may be designed to receive at least one signal (e.g., a Wi-Fi signal, a GPS signal, or a Long Term Evolution (LTE) signal) having a higher frequency in comparison with a signal received through the first antenna 210. Further, since the second antenna 220 receives a high frequency band signal, it may have a short antenna length. In an exemplary implementation, the second antenna 220 may be installed inside the connector 200. Furthermore, the connecting unit 240 of the connector 200 connects the earphone device with another terminal device. In this case, the terminal device is a device that separately receives and processes dual band signals received from the earphone antenna device. In this case, an external terminal device may be a portable terminal (e.g., a Moving Picture Experts Group (MPEG)-1 or MPEG-2 Audio Layer III (MP3) player, a tablet, and the like).

An exemplary configuration of the mobile terminal 300 will now be described. The mobile terminal includes a first band filter 310, a first matching unit 320, a second band filter 330, a second matching unit 340, a Low Noise Amplifier (LNA) 350, a first Electrostatic Discharge (ESD) unit 371 and a second ESD unit 373. The first band filter 310 filters a first band signal from a signal received through the first antenna 210, and the second band filter 330 filters a second band signal from a signal received through the second antenna 220. The first ESD unit 371 connects with an output terminal of the first band filter 310, and restrains a surge in the first band signal. The matching unit 320 matches impedance of a signal output from the first band filter 310. The signal processor 360 includes a first band signal processor 361 that converts a frequency of the first band signal to obtain a baseband signal. The second ESD unit 373 connects with an output terminal of the second band filter 330, and restrains a surge in the second band signal. The second matching unit 340 matches impedance of a signal output from the second band filter 330. The LNA 350 low-noise-amplifies a second weak band signal. The second band signal processor 363 converts a frequency of the second band signal to obtain a baseband signal. The first band signal processor 361 and the second band signal processor 363 may be implemented by the signal processor 360 configured by one IC circuit or may be separately implemented. The signal processor 360 may be configured by a frequency converter down-converting a frequency of a received RF signal to output a baseband signal. In this case, a demodulator and a decoder are connected to a next terminal of the signal processor 360, and may process a corresponding band signal. The signal processor 360 may include the demodulator and the decoder in addition to the frequency converter.

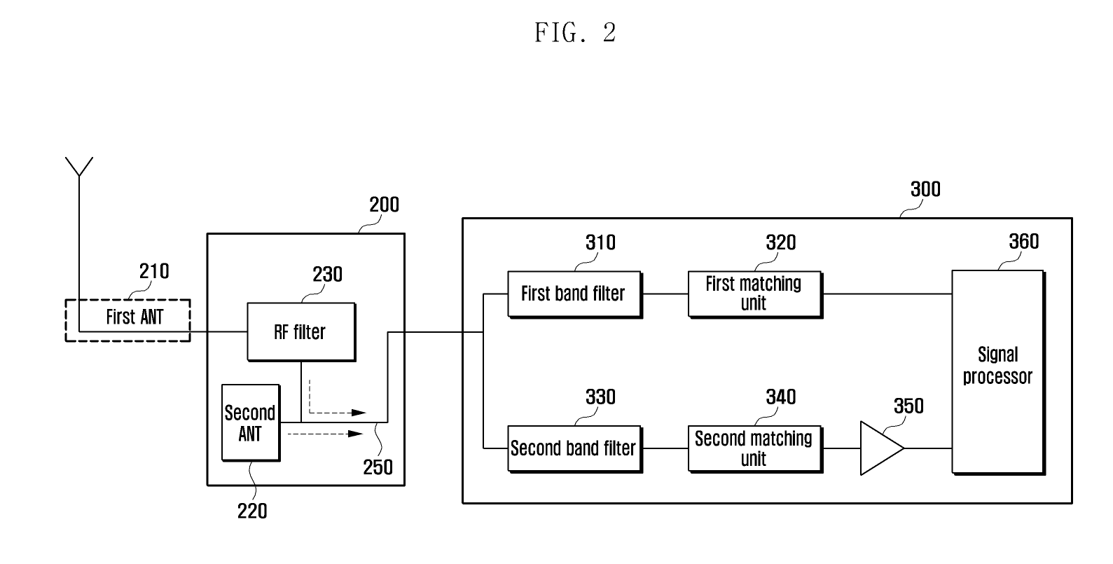

FIG. 2 is a block diagram illustrating an earphone antenna device with a multiple resonance antenna according to an exemplary embodiment of the present invention. Hereinafter, it is assumed that the first antenna 210 is a T-DMB antenna, a second antenna 220 is an S-DMB antenna, a first band is a T-DMB band, and a second band is an S-DMB band.

Referring to FIG. 2, a T-DMB antenna 210 receiving a first band frequency may be a wire antenna connected between an earphone 110 and a connector 200 of an earphone antenna device as illustrated in FIG. 1, which is installed separately from an audio line. In this case, the T-DMB antenna 210 may be made of copper as a conductor. A configuration of the antenna connector 200 will be described in more detail below. An RF filter 230 connects with the T-DMB antenna 210, and filters a T-DMB signal of a first frequency band but restrains band signals. The RF filter 230 may be configured by a low pass filter or a band pass filter capable of filtering a T-DMB band signal. Meanwhile, the RF filter 230 may be configured by an RF choke circuit. In this case, the RF filter 230 is designed to have characteristics in that Z=50Ω in a T-DMB band, and Z=open in an S-DMB band. Accordingly, the RF filter 230 passes only the T-DMB band signal but restrains an S-DMB band signal. The output of the RF filter 230 is transferred to a mobile terminal 300 through a path 250. In this case, the path 250 may become a Printed Circuited Board (PCB) pattern as a conductor, and be implemented by a micro-strip line.

The S-DMB antenna 220 receiving the second band frequency is installed inside the antenna connector 200 and connects with the path 250. The S-DMB antenna 220 receives an S-DMB signal of a second band, and the received S-DMB signal is provided to a mobile terminal through the path 250. In this case, the S-DMB antenna 220 may be configured in the form of S-DMB coil Antenna (ANT), S-DMB wire ANT, or S-DMB pattern ANT, and the length of the antenna is λ/4 or λ/2.

As described above, the antenna connector 200 includes a second antenna receiving a second band frequency higher than a second band frequency therein. The first band frequency signal and the second band frequency signal are separated and transferred to the mobile terminal 300, as illustrated in FIG. 1, through an RF filter 230. That is, in the signal received through the first antenna 210, only a signal of a first frequency band is passed and transferred to the path 250, but a signal of a frequency band is restrained through the RF filter 230. The second antenna 220 transfers a second band signal to the path 250. Accordingly, the antenna connector 220 receives signals from the first antenna 210 and the second antenna 220, and transfers the received signals to the mobile terminal 300.

As described above, an earphone antenna device according to an exemplary embodiment of the present invention connects with an earphone 110. The earphone antenna device is configured in the form of a wire that is separate from an audio line (not illustrated), and includes a first antenna 210 for receiving a first band signal and a connector 200 for connecting the earphone 110 to a terminal device 300. The connector 200 includes an RF filter 230 connected to the first antenna 210 for filtering the first band signal and for restraining other band signals, and a second antenna 220 connected between the RF filter 230 and an internal path 250 of a connector 200 connected to the terminal device 300 and for receiving a second band signal. Accordingly, the earphone antenna device transfers the first band signal received through the first antenna 210 and the second band signal received through the second band signal to the terminal device 300 through the internal path 250.

In this case, the second antenna may have a λ/4 length of the second band signal, and may be configured in the form of a wire, a coil, or a pattern. Further, the connector may be a micro-USB or T20 pin connector. The terminal device 300 includes a first band filter 310 for filtering the first band signal and a second band filter 330 for filtering the second band signal, and may select and process an output of a band filter corresponding to a selection of a user. As described above, when the first band is a T-DMB band and the second band is an S-DMB band, the first antenna 210 receives a T-DMB band signal and the second antenna 220 an S-DMB band signal.

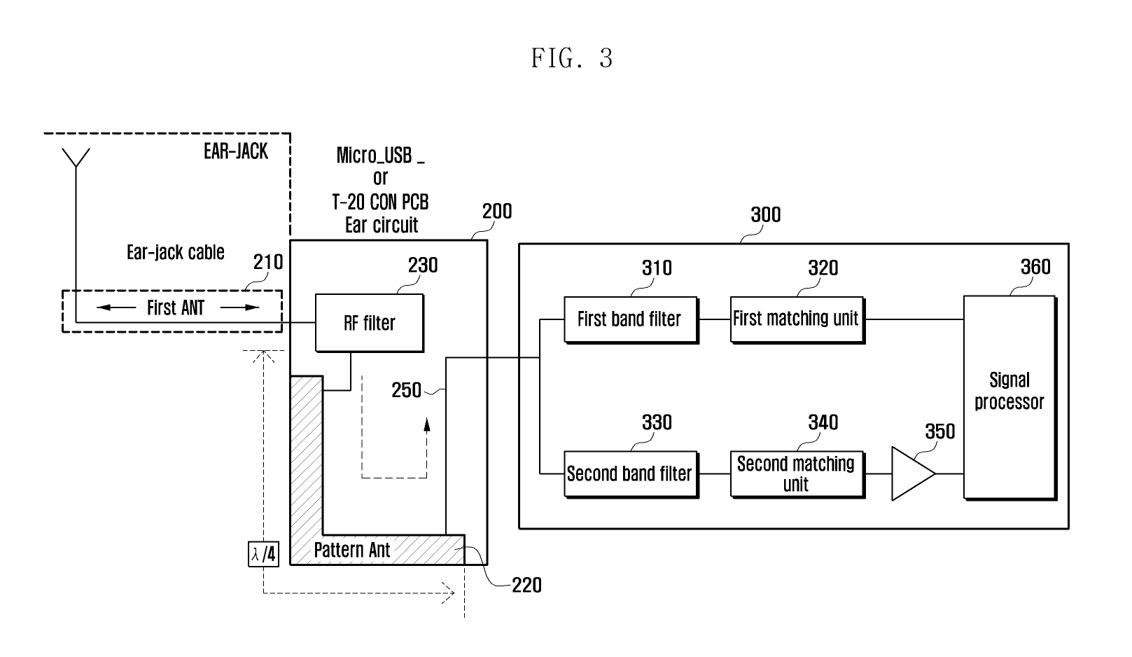

FIG. 3 is a block diagram illustrating a second antenna configured in the form of a pattern according to an exemplary embodiment of the present invention.

Referring to FIG. 3, the second antenna 220 receiving an S-DMB signal of a second band frequency is configured in the form of an S-DMB pattern Antenna (ANT) located between an RF filter 230 and a path 250 on an internal PCB of an antenna connector 200, and is designed to have a λ/4 length in an S-DMB band of a second band frequency. That is, the S-DMB antenna 200 is designed to have characteristics (Z=50Ω@2642 MHz, Z=open@174 MHz-212 MHz) that restrains a T-DMB band signal but passes an S-DMB band signal.

Accordingly, the earphone antenna device receives a first band frequency through a first antenna 210 in the form of a wire located at an exterior of the antenna connector 200, restrains signals except for the first band frequency and transfers the first band frequency to the path 250 through the RF filter 230. Further, a second band frequency received through the second antenna 220 located inside the antenna connector 200 is transferred to the path 250. Next, the first and second band frequencies transferred to the path 250 are provided to the mobile terminal 300. Accordingly, the mobile terminal 300 separates and filters a first band frequency and a second band frequency of a dual band received from the antenna earphone device. In this case, when the first band is a T-DMB band and the second band is an S-DMB band, the first band filter 310 may be configured by a low pass filter for filtering a T-DMB signal of 174 MHz-212 MHz and the second band filter 330 may be configured by a high pass filter for filtering an S-DMB signal of 2642 MHz. Accordingly, the mobile terminal may selectively play the received T-DMB signal or S-DMB signal according to a selection of a user.

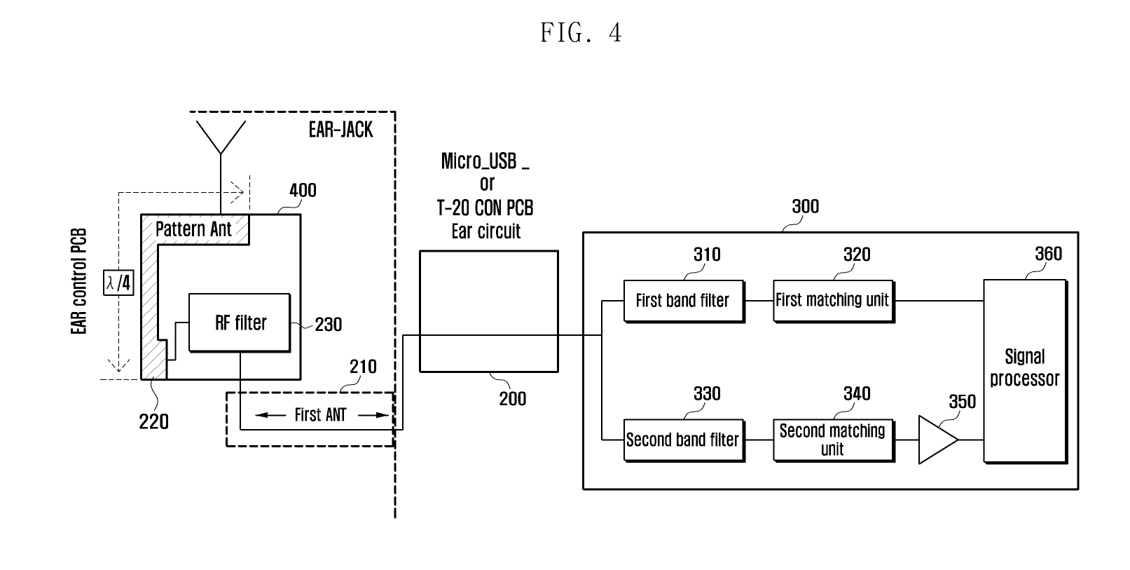

FIG. 4 is a block diagram illustrating an earphone antenna device with a multiple resonance antenna according to an exemplary embodiment of the present invention.

Referring to FIG. 4, an S-DMB antenna 220 is installed at a case 400 between an earphone 110 of FIG. 1 and a T-DMB antenna 210, and an antenna connector 200 for connecting the earphone antenna device to the mobile terminal 300. In this case, the case 400 may become a volume controller 120 of FIG. 1. The case 400 includes an S-DMB antenna 220 and an RF filter 230 therein.

A configuration of the case 400 will be described. The S-DMB antenna 220 connects with the earphone 110 of FIG. 1. The S-DMB antenna 220 receives an S-DMB band signal, and the received S-DMB band signal is transferred to an RF filter 230. In this case, the S-DMB antenna 220 may be configured in the form of an S-DMB coil ANT, an S-DMB wire ANT, or an S-DMB pattern ANT, and the length of an antenna is λ/4 or λ/2. FIG. 4 illustrates an example in which the S-DMB filter is configured by a pattern.

The RF filter 230 is connected between the S-DMB antenna 220 and the T-DMB antenna 210, and filters an S-DMB band signal and restrains other hand signals. The RF filter 230 may be configured by a high pass filter or a band pass filter. Further, the RF filter 230 may be configured by an RF choke circuit. In this case, the RF filter 230 is designed to have characteristics in that Z=open in a T-DMB band, and Z=50Ω in an S-DMB band. Accordingly, the RF filter 230 passes only the S-DMB band signal but restrains the T-DMB band signal.

An output of the RF filter 230 is transferred to a T-DMB antenna 210. Accordingly, the S-DMB signal and the T-DMB signal are transferred to the antenna connector 200. Then, the S-DMB signal and the T-DMB signal are transferred to a mobile terminal 300 through a path 205 of the connector 200. In this case, the path 250 may be a PCB pattern as a conductor, and may be implemented by a micro-strip line.

An earphone antenna device according to an exemplary embodiment of the present invention may include a case 400 connected to an earphone 110 and having a second antenna 220 therein, a first antenna 210 connected to the case 400 and configured in the form of a wire that is separate from an audio line, for receiving a first band signal, and a connector 200 connected to the first antenna 210 and connecting an earphone antenna device to a terminal device 300. The case 400 has a second antenna 220 connected to the earphone 110 for receiving a second band signal, and an RF filter 230 connected to the second antenna 220 for filtering a second band signal and for restraining other band signals. In this case, the earphone antenna device may transfer a first band signal received through the first antenna 210 and a second band signal received through the second antenna 220 to a terminal device 300 through an internal path 250 of FIG. 3.

In this case, the second antenna 220 has a λ/4 length of a second band signal, which may be configured in the form of a wire, a coil, or a pattern. Further, the case 400 may be a volume controller 120. The case 400 may be configured to have the second antenna 220 and the RF filter 230 inside a case of the volume controller 120 separately from a volume control circuit. In this case, when the first band is a T-DMB band and the second band is an S-DMB band, the first antenna 210 receives a T-DMB band signal and the second antenna 220 receives an S-DMB band signal.

As described above, an earphone antenna for a dual band according to an exemplary embodiment of the present invention may be used in two types of interfaces. More particularly, in a case of a broadcasting receiver, an earphone antenna device for a dual band of T-DMB/S-DMB may share a dual band antenna in an earphone to improve performance, and to reduce the number of antennas and manufacturing cost. When the user watches a DMB, an antenna may be arranged in a position that is favorable to a gripping location of the user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An earphone antenna device comprising:
a first antenna connected to an earphone, configured in the form of a wire that is separate from an audio line, for receiving a first band frequency; and
a connector connecting the earphone to a terminal device,
the connector comprises:
a Radio Frequency (RF) filter connected to the first antenna, for filtering the first band frequency and for restraining other band frequencies; and
a second antenna connected between the RF filter and an internal path of the connector connected to the terminal device, for receiving a second band frequency higher than the first band frequency,
wherein the first band frequency received through the first antenna and the second band frequency received through the second antenna are transferred to the terminal device through the internal path.

2. The earphone antenna device of claim 1, wherein the second antenna has a λ/4 length of the second band frequency and is configured in the form of a wire, a coil, or a pattern.

3. The earphone antenna device of claim 2, wherein the connector comprises at least one of a micro-Universal Serial Bus (USB) and a T20 pin connector.

4. The earphone antenna device of claim 3, wherein the terminal device comprises a first band filter for filtering the first band frequency and a second band filter for filtering the second band frequency, and selectively processes an output of a band filter corresponding to a selection.

5. The earphone antenna device of claim 4, wherein the first band is a Terrestrial-Digital Multimedia Broadcasting (T-DMB) band, the second band is a Satellite (S-DMB) band, the first antenna receives a T-DMB band frequency, and the second antenna receives an S-DMB band frequency.

6. The earphone antenna device of claim 4, wherein the first band is a Frequency Modulation (FM) band, the second band is a Wireless Fidelity (Wi-Fi) band, the first antenna receives an FM band frequency, and the second antenna receives a Wi-Fi band frequency.

7. An earphone antenna device comprising:
a case connected to an earphone and including a second antenna therein;
a first antenna connected to the case, configured in the form of a wire that is separate from an audio line, for receiving a first band frequency; and
a connector connected to the first antenna, for connecting the earphone antenna device to a terminal device,
the case comprises:
a second antenna connected to the earphone, for receiving a second band frequency; and
a Radio Frequency (RF) connected to the second antenna, for filtering the second band frequency and for restraining other band frequencies,
wherein the first band frequency received through the first antenna and the second band frequency received through the second antenna are transferred to the terminal device through an internal path of the connector.

8. The earphone antenna device of claim 7, wherein the second antenna has a λ/4 length of the second band frequency and is configured in the form of a wire, a coil, or a pattern.

9. The earphone antenna device of claim 8, wherein the case comprises a volume controller, and the antenna and the RF filter are installed inside a case of the volume controller separately from a volume control circuit.

10. The earphone antenna device of claim 9, wherein the terminal device comprises a first band filter for filtering the first band frequency and a second band filter for filtering the second band frequency, and selectively processes an output of a band filter corresponding to a selection.

11. The earphone antenna device of claim 10, wherein the first band is a Terrestrial-Digital Multimedia Broadcasting (T-DMB) band, the second band is a Satellite-DMB (S-DMB) band, the first antenna receives a T-DMB band frequency, and the second antenna receives an S-DMB band frequency.

12. The earphone antenna device of claim 10, wherein the first band is a Frequency Modulation (FM) band, the second band is a Wireless Fidelity (Wi-Fi) band, the first antenna receives an FM band frequency, and the second antenna receives a Wi-Fi band frequency.
